(19) United States
(12) Patent Application Publication
(10) Pub. No.: US 2016/0281807 A1
(43) Pub. Date: Sep. 29, 2016

(54) System and Method for Electro-Mechanical Brake Wear Adjustment

(71) Applicant: Caterpillar Inc., Peoria, IL (US)

(72) Inventors: John Kaufman, Yorkville, IL (US); Timothy Hinch, Kankakee, IL (US)

(73) Assignee: Caterpillar Inc., Peoria, IL (US)

(21) Appl. No.: 14/668,261

(22) Filed: Mar. 25, 2015

(51) Int. Cl. F16D 65/52; F16D 55/36

(52) U.S. Cl. CPC F16D 65/52; F16D 55/36

(57) ABSTRACT

A system and method for electro-mechanical brake wear adjustment includes an adjustable end plate configured to translate along an axis, a piston configured to translate along the axis relative to the adjustable end plate, a disc pack disposed between the adjustable end plate and the piston, such that movement of the piston toward the adjustable end plate compresses the disc pack against the adjustable end plate, the disc pack including a brake plate facing a brake disc, an actuator operatively coupled to the adjustable end plate and configured to move the adjustable end plate relative to the disc pack along the axis, and a controller operatively coupled to the actuator and configured to effect motion of the adjustable end plate via the actuator.

### TECHNICAL FIELD

The disclosure relates generally to systems and methods used in machine brakes and braking, and more particularly to automatically adjusting brake system components to address brake wear.

### BACKGROUND

Mobile machines may include a mechanical transmission drivingly coupled to opposing traction devices by way of front and/or rear differentials and final drives (one located between each differential and an associated traction device). Each differential receives a shaft power input from the transmission and produces two shaft power outputs directed through the final drives to the traction devices. The final drives may function to reduce a rotational speed of the differential output to a level appropriate to drive the associated traction devices and thereby propel the machine.

Each final drive may include a stationary housing, an axle rotatably disposed within the housing and driven by the differential, and a brake assembly connected between the housing and the axle. Some brake assemblies include a plurality of friction plates connected to rotate with the axle, a plurality of separator plates disposed between adjacent friction plates and rotationally constrained at their periphery by the housing, and a piston configured to push the friction plates and separator plates together, thereby transferring torque via friction between the friction plates and the separator plates to retard rotation of the axle. Such frictional torque transfer can result in brake wear.

U.S. Pat. No. 7,086,504 (“the '504 patent”), entitled “Disk brake comprising an adjuster module,” purports to address such brake wear. The '504 patent describes at least one adjusting system located in the brake caliper and arranged on one or more sides of the brake disc. In contrast, a process and system for automatically adjusting a mounting plate in response to brake wear is not known. These and other shortcomings of the prior art are addressed by this disclosure.

### SUMMARY

According to an aspect of the disclosure, a brake system for a machine includes an adjustable end plate configured to translate along an axis, a piston configured to translate along the axis relative to the adjustable end plate, a disc pack disposed between the adjustable end plate and the piston, such that movement of the piston toward the adjustable end plate compresses the disc pack against the adjustable end plate, the disc pack including a brake plate facing a brake disc, an actuator operatively coupled to the adjustable end plate and configured to move the adjustable end plate relative to the disc pack along the axis, and a controller operatively coupled to the actuator and configured to effect motion of the adjustable end plate via the actuator.

According to another aspect of the disclosure, a method for adjusting brake components on a machine includes sensing, with a controller having a sensor, at least one distance associated with a piston and at least one of an adjustable end plate and a disc pack having a disc and a plate, determining, with the controller having a processor, based on the determination of the at least one distance, whether the at least one distance is greater than a predetermined maximum distance, activating, with the controller, in response to determining that the at least one distance is greater than the predetermined maximum distance, an actuator configured to position an adjustable end plate, and positioning, with the actuator and in response to activating the actuator, the adjustable end plate.

### BRIEF DESCRIPTION OF THE DRAWINGS

FIG. 1 illustrates a perspective bottom view of a machine including a brake system, according to an aspect of the disclosure.

FIG. 2 illustrates a partial cross-sectional view of a brake system, according to an aspect of the disclosure.

FIG. 3 illustrates a cross-sectional view of a brake system, according to an aspect of the disclosure.

FIG. 4 illustrates a partial cutaway view of an actuator configured to adjust the position of the adjustable brake plate, according to an aspect of the disclosure.

FIG. 5 illustrates a process flow for collecting data associated with the brake system and adjusting the position of the adjustable end plate.

### DETAILED DESCRIPTION

Aspects of the disclosure will now be described in detail with reference to the drawings, wherein like reference numbers refer to like elements throughout, unless specified otherwise.

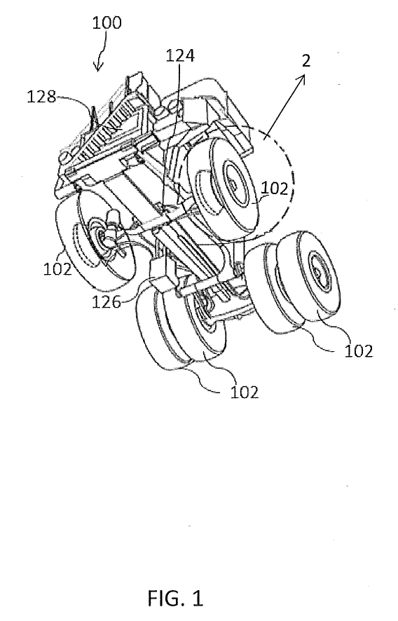

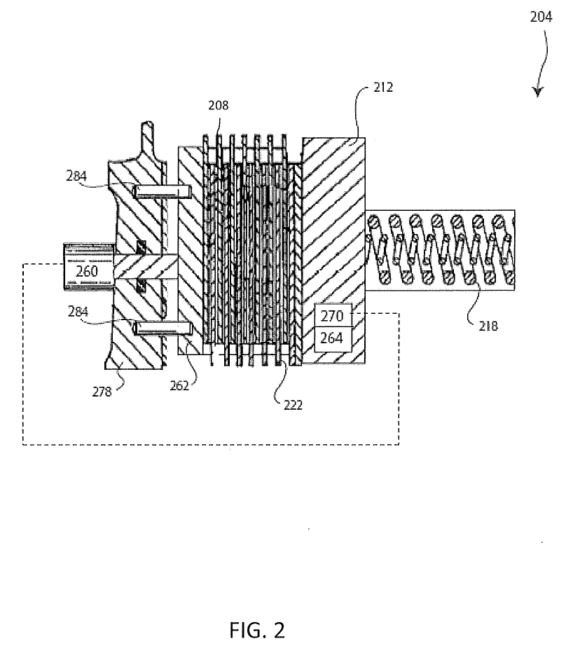

As shown in FIG. 1, the exemplary machine 100 includes one or more wheels 102 configured to support and propel the machine 100 on a ground surface (not shown) and a brake system (referred to in FIG. 1 as FIG. 2) operatively coupled to the wheels 102. The machine 100 further includes a pump 124 and a tank 126. The pump 124 may be driven by a prime mover such as an engine 128 or a motor (not shown).

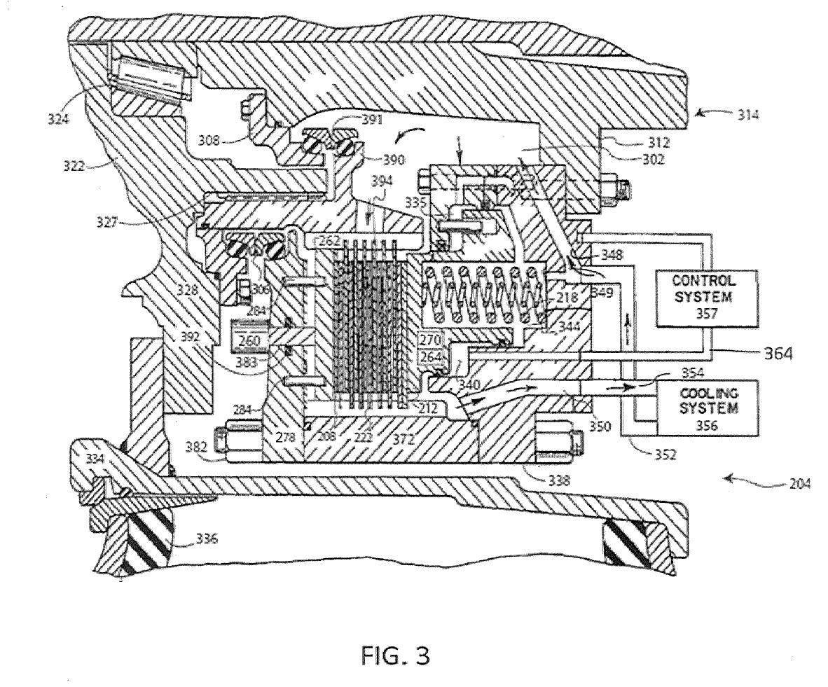

According to an exemplary aspect, as shown in FIG. 2, the brake system 204 may be a spring-applied disk brake system including one or more brake discs 208 and one or more brake plates 222 making a disc pack. The brake discs 208 may be connected to the wheel 102 shown in FIG. 1. The brake system 204 may include a piston 212 associated with at least one of the brake discs 208 on one side of the piston 212 and a compression spring 218 on the other side of the piston 212. The compression spring 218 may force the piston 212 toward the brake disc 208, and fluid pressure from the spring 218 side of the piston 212 may bias the piston 212 toward the brake disc 208 (see FIG. 3).

As the brake system 204 is applied, the piston 212 may move axially to apply the brake plate 222 and the brake disc 208 against an adjustable end plate 262. The brake disc 208 may be made of iron, steel, or the like. Friction between the brake disc 208 and the adjustable end plate 262 may cause the brake disc 208 to wear and decrease in thickness. As the brake discs 208 decrease in thickness, the piston 212 may have to increase the axial distance it must travel to force the brake plate 222 and brake disc 208 against the adjustable end plate 262.

The adjustable end plate 262 may be arranged between a fixed end plate 278 and the brake disc 208 and brake plate 222 so that the adjustable end plate 262 may axially move toward and away from the brake disc 208 and brake plate 222 and in between the brake disc 208 and brake plate 222 and the fixed end plate 278. The adjustable end plate 262 may be coupled with the fixed end plate 278 via pins 284 which may fit into apertures formed in both of the fixed end plate 278 and the adjustable end plate 262 (shown and explained in more detail in FIG. 3).

According to an aspect of the disclosure, a sensor 264 may be mounted on the piston 212, on the adjustable end plate 262, or elsewhere within or near the brake system 204 where the sensor 264 may determine the movement of the piston 212. In the example shown in FIG. 2, the sensor 264 is mounted on the piston 212. The sensor 264 may be configured to determine the distance between the piston 212 and the brake plate 222 and the brake disc 208, and/or the distance between the piston 212 and the adjustable end plate 262. As the brake discs 208 become worn, the distance that the piston 212 may travel to apply pressure with the brake plates 222 and brake discs 208 may increase. Increased distance between the piston 212 and brake plates 222, brake discs 208, and/or adjustable end plate 262 may affect the efficiency of the brake system 204. The sensor 264 may be configured to determine the distance the piston 212 is traveling to apply pressure with the brake plate 222 and the brake disc 208. The sensor 264 could be a proximity sensor, infrared, radar, encoder, linear encoder, Hall affect sensor, potentiometer, inductive position sensor, linear variable differential transformer, inductive proximity sensor, rotary encoder, incremental encoder, or the like.

The sensor 264 can also be part of and/or operatively linked to an electronic control module 270. The electronic control module 270 may also include a processor (not shown), a computer readable memory (not shown), and a transceiver (not shown). The processor can be, for example, dedicated hardware as defined herein, a computing device as defined herein, a programmable logic array (PLA), a programmable array logic (PAL), a generic array logic (GAL), a complex programmable logic device (CPLD), an application-specific integrated circuit (ASIC), a field-programmable gate array (FPGA), or any other programmable logic device (PLD) configurable to execute the functions for the electronic control module 270. The computer readable memory may include computer readable storage media, for example tangible or fixed storage of data, or communication media for transient interpretation of code-containing signals. Computer readable storage media, as used herein, refers to physical or tangible storage (as opposed to transient signals) and includes without limitation volatile and non-volatile, removable and non-removable storage media implemented in any method or technology for the tangible storage of information such as computer-readable instructions, data structures, program modules, or other data. In one or more aspects, the actions and/or events of a method, algorithm, or module may reside as one or any combination or set of codes and/or instructions on a computer readable memory or machine readable medium, which may be incorporated into a computer program product.

In another aspect of the disclosure, the distance data captured by the sensor 264 may be compiled by an electronic control module 270. The computer readable memory associated with the electronic control module 270 may include an operating system, a communication component, and the like. The operating system together with the various components may provide software functionality for the electronic control module 270. The computer readable medium may include a high-speed, random-access memory. Also, the computer readable medium may be a non-volatile memory, such as magnetic fixed disk storage, SIM, UICC, cloud-based memory, flash memory or the like. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules, or other data.

According to an aspect, the electronic control module 270 may determine based on distance data from the sensor 264 that the piston 212 is moving beyond a maximum predetermined distance. In response, the electronic control module 270 may be configured to automatically adjust the location of the adjustable end plate 262. For example, the electronic control module 270 may determine that the adjustable end plate 262 should move closer to the brake discs 208 so that as the brake discs 208 wear, the adjustable end plate 262 may be repositioned to decrease the distance between the brake discs 208 and the adjustable end plate 262.

The electronic control module 270 may be configured to communicate with an actuator 260. The electronic control module 270 may both transmit and receive signals. According to an aspect, when the electronic control module 270 has determined that the adjustable end plate 262 needs to be repositioned, the electronic control module 270 may transmit a signal to the actuator 260 to activate the actuator 260 to apply a force to the adjustable end plate 262 and thereby move the adjustable end plate 262 to a different location with respect to the brake discs 208 and brake plates 222.

According to an aspect, the adjustable end plate 262 may be adjusted by the actuator 260. The actuator 260 may be electrically powered or hydraulically powered. For instance, the actuator 260 may be a servomotor, a screw actuator, a solenoid valve with hydraulic pressure, or the like. The actuator 260 may apply a force that can be translated to the adjustable end plate 262 with a gear train, hydraulic pressure, or the like.

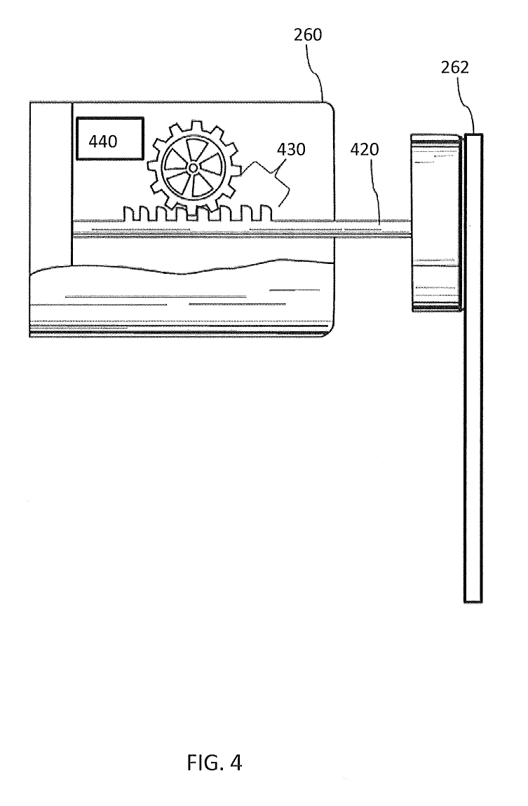

The actuator 260 may be powered by and configured to communicate with the electronic control module 270, which may receive power from a machine battery (not shown). The actuator 260 may also be powered by a battery and/or the main power source (not shown) on the machine 100. The adjustable end plate 262 may be coupled, such as, e.g., fastened, bolted, welded, screwed or the like, to the shaft 420 of the actuator 260 or otherwise attached to the actuator 260 (see FIG. 4). Thus, if the actuator 260 is instructed by the electronic control module 270 to adjust the placement of the adjustable end plate 262, the actuator 260 may engage the adjustable end plate 262 through the shaft 420. The actuator 260 movement may cause the attached adjustable end plate 262 to move closer to or away from the brake discs 208. The actuator 260 may communicate wirelessly with the electronic control module 270 on a communication channel as defined herein.

Further, it should be noted that the electronic control module 270 may embody any general machine controller capable of controlling the actuator. Examples of such circuitry may be, but not limited to, an application-specific integrated circuit (ASIC), signal-conditioning circuitry, communication circuitry, and other appropriate circuitry.

Although, it is disclosed herein that the brake system 204 is implemented in the machine 100 embodied as the large mining truck, a person having ordinary skill in the art may acknowledge that the machine 100 disclosed herein in exemplary in nature and hence, non-limiting of this disclosure. Any machine 100 including one or more rotatable members and a spring applied brake system operatively coupled to the rotatable members, which are embodied as the wheels 102 and the brake system 204 in the disclosure, may employ the hydraulic system disclosed herein.

With reference to FIG. 3, the brake system 204 of the present disclosure may be axially mounted outward, or to the left when viewing the drawing, of a radially extending flange 312. In the instant example, the flange 312 may be an integral part of a conically tapered axle housing 314 such as is found on a relatively large mining truck or the like. A drive train member 322 may be rotatably supported on the axle housing 314 to the outside of the brake system 204 by an antifriction bearing 324. The drive train member 322 may have an axially inwardly extending flange 328 with an external spline 327 thereon, and a radially outwardly extending flange 328. A wheel rim arrangement generally identified by the reference numeral 334 may be secured to the flange 328, and a tire 336 may be mounted thereon.

The brake system 204 may include an inner end plate 338 secured to flange 312 of the axle housing 314. Formed in this inner end plate 338 may be a radially inwardly extending inlet passage 348 and an axially oriented branch passage 349, as well as an outlet passage 350 axially extending therethrough, which may be respectively in fluid communication with an inlet conduit 352 and an outlet conduit 354. These conduits may be operationally connected to a cooling system 356 for the purpose of normally continuously circulating a cooling fluid through the brake system 204.

Centrally disposed about the periphery of the brake system 204 may be a cylindrical connecting shell 372 having a plurality of internal teeth (not shown) formed thereon. The cylindrical connecting shell 372 may extend axially in spanning relation between the inner end plate 338 and the adjustable end plate 262.

A connecting drum 390 may rotate with movement of the machine 100 and may have a plurality of external teeth 394 on which are keyed the brake discs 208. These brake discs 208 may be interleaved with the brake plates 222 which may be similarly keyed to the internal teeth of the connecting shell 372.

As is illustrated, the fixed end plate 278 and the adjustable end plate 262 may be arranged closely in relation to the external spline 327 of the wheel hub 322. The adjustable end plate 262 may be ring-shaped so that it has a cutout center. The fixed end plate 278 may be bolted to the connecting shell 372 via a bolt 382. The fixed end plate 278 may also serve as a ground base for the actuator 260. In order for the actuator 260 to be grounded to the fixed end plate 278, so that the actuator 260 may engage the adjustable end plate 262, the fixed end plate 278 may have an aperture or opening 383 allowing the actuator 260 to penetrate through the fixed end plate 278 with the shaft 420 (see FIG. 4) to engage the adjustable end plate 262. The actuator 260 may connect to or engage the surface of the adjustable end plate 262 in order to position the adjustable end plate 262. The actuator may be lined with a pair of seals 392 within the aperture to prevent fluid leakage and to limit the axial movement of the adjustable end plate 262. To facilitate the axial movement of the adjustable end plate 262, a pair of pins 284 may connect the adjustable end plate 262 to the fixed end plate 278.

In this example, an internal seal arrangement 391 may be arranged between the axel housing 314 and the rotatable connecting drum 390, and an external seal arrangement 306 may be arranged between the fixed end plate 278 and the adapter member 308 secured to the axel housing 314. The external seal arrangement 306 may be needed to contain fluid from the inlet conduit 352, the inlet passage 348, and an annular chamber 302. The fluid may be routed back to the cooling system 356 via the outlet passage 350. To maintain the external seal arrangement 306, the fixed end plate 278 may remain fixed while the adjustable end plate 262 may change positions by moving axially toward or away from the brake discs 208 and brake plates 222.

To adjust the positioning of the adjustable end plate 262 relative to the brake discs 208 and brake plates 222, the adjustable end plate 262 may be attached to at least one actuator 260 configured to axially move the adjustable end plate 262 toward or away from the brake discs 208 and brake plates 222. It may be desirable to move the adjustable end plate 262 closer to the brake discs 208 and brake plates 222 as the brake discs 208 and brake plates 222 wear, increasing the distance that the brake piston 212 must travel to reach the brake discs 208 and brake plates 222 and compress them onto the adjustable end plate 262. The actuator 260 may be affixed to the fixed end plate 278 to facilitate the axial movement of the nearby adjustable end plate 262.

In accordance with one aspect of the disclosure, the brake system 204 may be fully peripherally cooled by the circulation of fluid from the inlet conduit 352, the inlet passage 348, to the internal annular chamber 302 and to the interleaved brake discs 208 and brake plates 222. Subsequently, the fluid may be routed axially inwardly back to the cooling system 356 by way of the outlet passage 350 and outlet conduit 354.

In accordance with one aspect'of the disclosure, the control system 357 may allow only a predetermined volume of fluid to be exhausted from the chamber 340 upon the selective release of service braking by the machine 100 operator. The allowance of a volume of fluid to be exhausted from the chamber 340 may permit limited retracting of the piston 212 axially away from the brake discs 208 and brake plates 222, and may automatically adjust any slack to a predetermined value to thereby improve service braking response upon the reengagement thereof. For example, the volume of fluid exhausted from the chamber 340 may be limited to an amount sufficient to provide approximately 0.005 inch clearance (0.0127 centimeters) between each of the brake discs 208 and the brake plates 222. The limiting of fluid exhausted from chamber 340 may minimize the drag and power loss while simultaneously limiting the maximum amount of travel distance of the piston 212 independently of any wear of the brake discs 208 and brake plates 222 so that the brake discs 208 and brake plates 222 may be rapidly reengaged.

A spring chamber 344 may be defined intermediate to the piston 212 and the inner end plate 338, and the inlet conduit 352 may allow cooling fluid pressure to be communicated there. The presence of cooling fluid in the spring chamber 344 may result in a force tending to move the piston 212 leftward in opposition to the force resulting from substantially the same pressure acting thereon in the annular chamber 302.

When service braking is desired, the machine 100 operator may manipulate the control system 357 to selectively supply pressure to the chamber 340 through the conduit 364. With no fluid pressure present in either of the chambers 335 or 340, such as may normally take place under parking conditions, the compression spring 218 may apply a relatively substantial force serving to bias the brake piston 212 leftward when viewing the drawing. The force from the compression spring 218 may force the brake piston 212 against the brake discs 208 and brake plates 222 to compress them against the adjustable end plate 262. Alternatively, an intermediate plate (not shown) may provide an intermediate layer between the brake discs 208 and the adjustable end plate 262 so that the contact between the brake discs 208 and the adjustable end plate 262 is indirect, but that the force from the compression spring 218 may still be transferred onto the adjustable end plate 262 to apply the brake system 204.

The brake discs 208 may be frictionally coupled to the support structure including the connecting shell 372, the adjustable end plate 262, and the axle housing 314, to hold the connecting drum 390, wheel hub 322, and the wheel rim arrangement 334 in a fixed position.

As the piston 212 moves leftward in FIG. 3, the piston 212 may engage the brake discs 208 to push the brake discs 208 against the adjustable end plate 262. When the distance that the piston 212 must move to apply pressure to the brake discs 208 exceeds a predetermined maximum distance, the electronic control module 270 may determine that the adjustable end plate 262 may need to be repositioned. The adjustable end plate 262 may need to be moved closer to the brake discs 208 to reduce the distance the piston 212 must travel to compress the brake discs 208 and brake plates 222 onto the adjustable end plate 262. In order to accomplish the adjustment, the electronic control module 270 may activate the actuator 260, which may in turn adjust the positioning of an attached or engaged adjustable end plate 262 until the electronic control module 270 determines based on data from the sensor 264 that the piston 212 distance traveled is acceptable. Thus the sensor 264 may regularly sense distance data and communicate the distance data to the electronic control module 270 for evaluation.

FIG. 4 shows a more detailed view of an actuator 260, specifically a servomotor in this aspect. The actuator 260 may have gears 430 to create an output force. The output force may be transferred via a shaft 420. The shaft 420 may be connected to the adjustable end plate 262 on one side or may be arranged to engage the adjustable end plate 262 on the circular surface of the adjustable end plate 262 that surrounds the cutout center of the adjustable end plate 262. The actuator 260 may be configured to communicate wirelessly or wired (along a communication channel as defined herein) with the electronic control module 270. To communicate wirelessly, the actuator 260 may have a receiver 440 which may be part of a transceiver. The receiver 440 may be configured to receive signals from the electronic control module 270 to activate the actuator 260. Activation of the actuator 260 may include activating the gears 430 to move the shaft 420. According to an aspect, rotation of the gears 430 may result in movement of the shaft 420 toward or away from the actuator 260.

The actuator 260 may be arranged so that movement of the shaft 420 toward or away from the actuator may correspond in movement of the shaft 420 toward or away from the brake discs 208 and brake plates 222. In such an aspect, as the gears 430 may rotate and correspondingly move the shaft 420 toward the brake discs 208 and brake plates 222, the adjustable end plate 262 that may be connected to or engaged by a side of the shaft 420 may correspondingly move with the shaft 420 toward the brake discs 208 and brake plates 222 in order to reduce the distance that the piston 212 (see FIG. 3) must travel to compress the brake discs 208 and brake plates 222 onto the adjustable end plate 262. In some configurations, it may also be desirable to use more than one actuator 260 to position the adjustable end plate 262. If more than one actuator 260 is used to position the adjustable end plate 262, each actuator 260 may be connected to or configured to engage the circular surface surrounding the cutout center of the adjustable end plate 262.

The disclosure may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), Long Term Evolution (LTE), W-CDMA (Wideband Code-Division Multiple Access), Wireless Fidelity (Wi-Fi), Bluetooth, and/or the like, and/or a combination of two or more thereof.

### INDUSTRIAL APPLICABILITY

This disclosure could be applied to any brake system for a mobile machine or other systems having a brake system. The system and process may increase brake efficiency, improve operation of the machine using the brake system, and reduce the need for component repairs and replacements.

Referring to FIGS. 3 and 4, if the brake discs 208 and brake plates 222 have worn to the degree that the piston 212 may have to travel a longer distance than is optimal to engage the brake discs 208 and brake plates 222 onto the adjustable end plate 262, the position of the adjustable end plate 262 may be adjusted. As brakes are applied during the operation of the machine 100, the electronic control module 270 may activate the sensor 264 to read at least one distance involving the piston 212 and the brake discs 208, brake plates 222, and/or adjustable end plate 262. The at least one distance measured by the sensor 264 may be provided to the electronic control module 270, which may determine if the at least one distance is within a predetermined acceptable limit If the at least one recorded distance is outside of a predetermined limit, then the electronic control module 270 may activate the actuator 260 to adjust the position of the adjustable end plate 262.

The adjustable end plate 262 may be configured to move toward and away from the brake discs 208 and brake plates 222. To accomplish this movement, the adjustable end plate 262 may be attached to or engaged by an actuator 260 configured to axially move the adjustable end plate 262 toward or away from the brake discs 208 and brake plates 222. It may be desirable to move the adjustable end plate 262 closer to the brake discs 208 and brake plates 222 as the brake discs 208 wear, increasing the distance that the brake piston 212 must travel to apply the brake discs 208 and brake plates 222 to the adjustable end plate 262. The actuator 260 may be a servo motor, a screw actuator, a solenoid valve, or the like.

The adjustable end plate 262 or the brake piston 212 may be configured with at least one sensor 264 to communicate with an electronic control module 270, which may record data from at least one sensor 264. The sensor 264 may be configured to detect the distance between the brake piston 212 and the brake discs 208 and brake plates 222, and/or the distance between the brake piston 212 and the adjustable end plate 262. Data related to these distances may be stored in the electronic control module 270, which may contain a processor (not shown) and computer readable memory (not shown).

In accordance with one aspect of the disclosure, the electronic control module 270 may determine based on sensor 264 data that a distance related to the piston 212 is beyond a maximum predetermined value. In response, the transceiver of the electronic control module 270 may send a signal to activate the actuator 260 to adjust the positioning of the adjustable end plate 262.

The receiver 440 of the actuator 260 may receive the signal from the transceiver of the electronic control module 270. In response, the actuator 260 may activate. Activation may include rotating gears 430 of the actuator 260 to create an output force. The output force may be transferred via a shaft 420 so that when the gears 430 rotate, the shaft 420 may move toward the brake discs 208 and brake plate 222. The adjustable end plate 262 may be connected to a proximal side of the shaft 420 so that when the shaft 420 moves toward the brake plates 222 and the brake plates 222, the adjustable end plate 262 also moves toward the brake discs 208 and brake plates 222 as a result. The result of this repositioning of the adjustable end plate 262 may be a reduction in the distance the piston 212 may have to move to engage the brake discs 208 and brake plates 222 so that the brake system 204 operates more effectively as brakes wear.

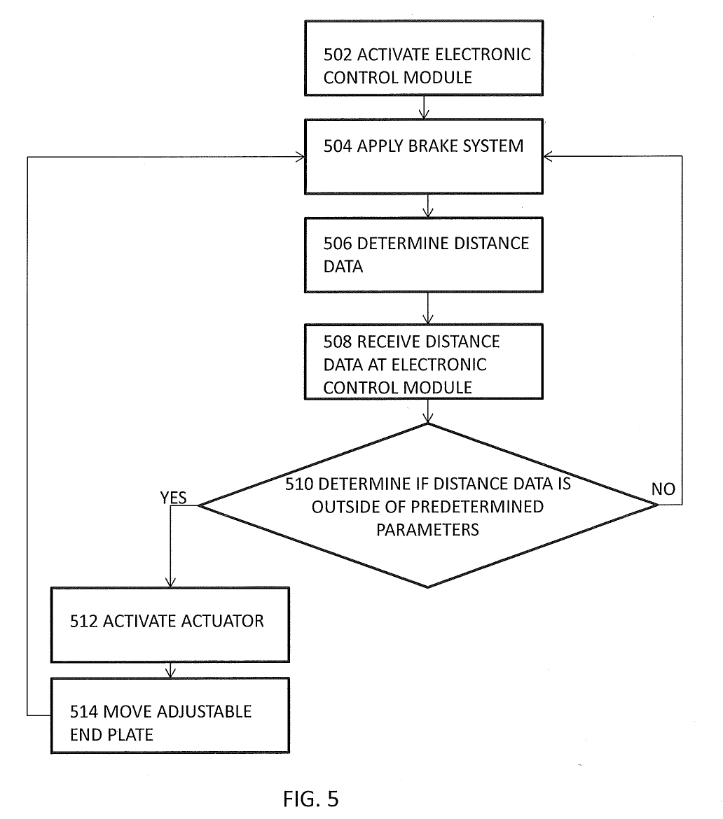

FIG. 5 shows the process of adjusting the position of the adjustable end plate 262. At step 502, the electronic control module 270 may be activated. Activation of the electronic control module 270 may include activation of any sensors 264 associated with the electronic control module 270. Once the electronic control module 270 has been activated at step 502, the brake system 204 may be applied at step 504. When the brake system 204 is applied, the sensor 264 may determine data associated with the movement of the piston 212 in step 506. The electronic control module 270 may be configured to receive the data at step 508.

Once the electronic control module 270 has received the data associated with the movement of the piston 212 in step 508, the electronic control module 270 may determine whether the distance data has exceeded any predetermined parameters at step 510. If the distance data is outside of any predetermined parameters, the electronic control module 270 may activate the actuator 260 at step 512. If the distance data is not outside of any predetermined parameters, the process returns to step 504 when the brake system 204 is applied. Once the actuator 260 has been activated at step 512, the actuator 260 may operate to move the adjustable end plate 262 at step 514. The process then may repeat with the application of the brake system 204 in step 504 as a feedback loop to continue to determine, as the brake system 204 is applied, whether or not the adjustable end plate 262 needs repositioning.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A brake system for a machine, comprising:
an adjustable end plate configured to translate along an axis;
a piston configured to translate along the axis relative to the adjustable end plate;
a disc pack disposed between the adjustable end plate and the piston, such that movement of the piston toward the adjustable end plate compresses the disc pack against the adjustable end plate, the disc pack including a brake plate facing a brake disc;
an actuator operatively coupled to the adjustable end plate and configured to move the adjustable end plate relative to the disc pack along the axis; and
a controller operatively coupled to the actuator and configured to effect motion of the adjustable end plate via the actuator.

2. The system of claim 1, further comprising a shaft associated with the actuator, the shaft attached to the adjustable end plate and configured to axially position the adjustable end plate in response to a force generated by the actuator.

3. The system of claim 1, wherein the controller is configured to activate the actuator to position the adjustable end plate in response to the controller determining that a distance associated with the piston and at least one of the disc pack and the adjustable end plate has exceeded at least one predetermined distance criteria.

4. The system of claim 1, wherein the controller has a sensor configured to detect a distance associated with the piston and at least one of the disc pack and the adjustable end plate.

5. The system of claim 4, wherein the sensor is positioned on the piston.

6. The system of claim 4, wherein the controller is further configured to determine, in response to the sensor detecting the distance associated with the piston and at least one of the disc pack and the adjustable end plate, that the distance associated with the piston and at least one of the disc pack and the adjustable end plate has exceeded a predetermined distance criteria.

7. The system of claim 6, wherein the predetermined distance criteria includes at least one of the following: the distance between the piston and the at least one brake disc, the distance between the piston and the adjustable end plate, and the distance between the adjustable end plate and the at least one brake disc.

8. The system of claim 1, wherein the actuator is configured to receive a signal from the controller activating the actuator to adjust a position of the adjustable end plate.

9. The system of claim 8, wherein the actuator includes a receiver configured to communicate wirelessly with the controller.

10. A method for adjusting brake components on a machine, the method comprising:
sensing, with a controller having a sensor, at least one distance associated with a piston and at least one of an adjustable end plate and a disc pack having a disc and a plate;
determining, with the controller having a processor, based on the sensing of the at least one distance, whether the at least one distance is greater than a predetermined maximum distance;
activating, with the controller, in response to determining that the at least one distance is greater than the predetermined maximum distance, an actuator configured to position the adjustable end plate; and
positioning, with the actuator and in response to activating the actuator, the adjustable end plate.

11. The method of claim 10 wherein the at least one distance associated with a piston includes at least one of the following: the distance between the piston and the brake disc, the distance between the piston and the adjustable end plate, and the distance between the adjustable end plate and the brake disc.

12. The method of claim 10, wherein activating further includes the controller communicating wirelessly with the actuator.

13. The method of claim 10, wherein determining whether the at least one distance is greater than the predetermined maximum distance is performed by the controller configured to receive distance data from the sensor and having a computer readable memory with the predetermined maximum distance stored thereon.

14. The method of claim 10, wherein positioning the adjustable end plate includes activating a servo motor configured to engage the adjustable end plate.

15. The method of claim 14, wherein positioning the adjustable end plate further includes activating a gear train configured to move the adjustable end plate.

16. The method of claim 10, wherein positioning the adjustable end plate includes activating a solenoid configured to engage the adjustable end plate.

17. The method of claim 10, wherein sensing further includes detecting at least one distance associated with the piston and at least one brake disc, at least one brake plate, and the adjustable end plate.

18. The method of claim 10, wherein the adjustable end plate is connected to a side of a shaft of the actuator configured to position the adjustable end plate when the actuator is activated.

19. The method of claim 18, wherein positioning further includes moving the shaft and adjustable end plate toward the brake disc and the brake plate in response to determining that the at least one distance is greater than a predetermined maximum distance.

20. The method of claim 12, wherein activating further includes the controller transmitting a signal to the actuator, in response to determining that the at least one distance is greater than the predetermined maximum distance, to activate a gear train to move the adjustable end plate toward the brake disc and the brake plate.
